(19) United States
(12) Patent Application Publication
(10) Pub. No.: US 2023/0399468 A1
(43) Pub. Date: Dec. 14, 2023

(54) BIO-BASED SULFONE COPOLYMERS FREE OF BPA AND BPS

(71) Applicant: Solvay Specialty Polymers USA, LLC, Alpharetta, GA (US)

(72) Inventors: Atul BHATNAGAR, Alpharetta, GA (US); Keshav S. GAUTAM, Suwanee, GA (US)

(21) Appl. No.: 18/036,414

(22) PCT Filed: Dec. 10, 2021
(86) PCT No.: PCT/EP2021/085287

§ 371 Date: May 11, 2023

Related U.S. Application Data
(60) Provisional application No. 63/127,170, filed on Dec. 18, 2020.

(30) Foreign Application Priority Data
Mar. 4, 2021 (EP) 21160654.6

(51) Int. Cl. C08G 75/23; C08G 65/40; C08J 5/18; C08J 5/22

(52) U.S. Cl. CPC C08G 75/23; C08G 65/4056; C08J 5/18; C08J 5/2256; C08J 2381/06; C08J 2371/02

(57) ABSTRACT

A bio-based poly(arylether sulfone) copolymer (“copolymer b-PAES”) comprises at least two sulfone recurring units derived from two distinct dihydroxy/diol monomers: a bio-compatible and bio-based diol momoner and a bisphenol monomer distinct from Bisphenol S (BPS) and Bisphenol A (BPA). The dihydroxy bisphenol monomer comprises a substituted-phenol bisphenolic compound distinct from BPS and BPA, preferably comprises a bisphenol F derivative with both alkyl substituted-phenol groups. The bio-based diol monomer comprises at least one diol selected from isosorbide, isomannide and/or isoidide. The copolymer b-PAES is preferably free of BPA and BPS. A process for manufacturing such copolymer b-PAES, its use for manufacturing an article, an article made therefrom such as membranes, and a polymer solution for manufacture of membrane comprising such copolymer b-PAES.

### CROSS-REFERENCE TO RELATED APPLICATIONS

This application claims priority to U.S. provisional application U.S. Ser. No. 63/127,170 filed on Dec. 18, 2020 and to European patent application EP 21160654.6 filed on Mar. 4, 2021, the whole content of these applications being incorporated herein by reference for all purposes.

### TECHNICAL FIELD

The present invention pertains to a bio-based polyarylene ether sulfone copolymer b-PAES derived from a bisphenolic compound with at least one substituted-phenol group, at least one bio-based diol monomer and a dihalo monomer, to a process for manufacturing such copolymer, to a polymer solution containing such copolymer, to articles comprising or made from such copolymer, and to its use for the manufacture of articles. The copolymer b-PAES and articles comprising it or made therefrom are particularly free of 4,4′-dihydroxydiphenyl sulfone (BPS) and 4,4′-isopropylidenediphenol (BPA).

### BACKGROUND

Poly(aryl ether sulfone) (PAES) polymers are a class of thermoplastic polymers characterized by high glass-transition temperatures, good mechanical strength and stiffness, and outstanding thermal and oxidative resistance. By virtue of their mechanical, thermal, and other desirable characteristics, these polymers are used increasingly making products for a wide and diversified range of commercial applications, for instance in coatings, in membranes for wide field of use including medical market, due to their excellent mechanical and thermal properties, coupled with outstanding hydrolytic stability. PAES is a generic term used to describe any polymer containing at least one sulfone group (—SO₂—), at least one ether group (—O—) and at least one arylene group.

A commercially important group of PAES includes polysulfone polymers identified herein as polysulfones, in short PSU. PSU polymers contain recurring units derived from the condensation of the dihydroxy monomer bisphenol A (BPA) and a dihalogen monomer, for example 4,4′-dichlorodiphenyl sulfone (DCDPS). Such PSU polymers are commercially available from Solvay Specialty Polymers USA LLC under the trademark UDEL®. The structure of the recurring units of such a PSU polymer is shown below:

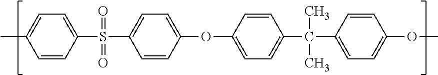

PSU polymers have a high glass transition temperature (e.g., about 185° C.) and exhibit high strength and toughness.

Another important group of PAES includes polyethersulfone polymers, in short PES. PES polymers derive from the condensation of the dihydroxy monomer bisphenol S (BPS) and a dihalogen monomer, for example 4,4′-dichlorodiphenyl sulfone (DCDPS). Such PES polymers are commercially available from Solvay Specialty Polymers USA LLC under the trademark VERADEL®. The structure of the recurring units of such a PES polymer is shown below:

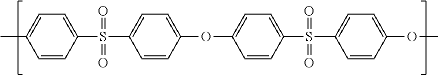

PSU and PES polymers, respectively based on BPA and BPS, are frequently used to prepare membranes to be used in contact with biological fluids, for example blood.

BPA and BPS are industrial chemicals that have been present in many articles, including plastic bottles and food and beverage cans since the 1960s. In recent years, concerns have been raised about BPA and BPS's safety. BPS and BPA are suspected to be endocrine disruptive in nature, albeit without conclusive research, and their impact on the environment and human health is still under investigation. In view of this controversy, the market is looking for economically viable alternatives to BPA and BPS.

Previous efforts in developing new polymeric materials made from monomers which have weak binding affinity for estrogen receptors can be found for example in US 2014/0113093 (SOLVAY SPECIALTY POLYMERS USA, LLC) and by work done by Sundell and coworkers (Sundell et al. (2014) Polymer, vol. 55(22), pp. 5623-5634).

Because polymeric materials in contact with food and drugs must meet certain requirements mandated by for instance the FDA, the European Food Safety Agency and the Environmental Protection Agency (EPA), it is important to continue developing polymeric materials that are safe both for humans and environment for applications requiring contact with water, food, drugs and/or blood.

The development of renewable polymers derived from bio-based feed-stocks is also of particular interest. This is part of efforts oriented towards reduction of the amount of petroleum consumed in the chemical industry and to open new high-value-added markets to agriculture; 1,4:3,6-dianhydrohexitols are examples of such chemicals used as bio-based feed-stock.

Interest in the production of 1,4:3,6-dianhydrohexitols, especially isosorbide, has been generated by potential industrial applications including the synthesis of polymers such as notably polyesters, polyethers, polyurethanes and polyamides. The use of 1,4:3,6-dianhydrohexitols in polymers, and more specifically in polycondensates, can be motivated by several features: they are rigid molecules, chiral, and non-toxic. For these reasons, there are expectations that polymers with high glass transition temperature and/or with special optical properties can be synthesized.

The industrial production of such monomers is a developing area, quickly making available this feedstock at more and more attractive prices. Moreover, interest in chemicals derived from renewable resources is increasing and becoming a decisive argument: as the carbon contained in bioplastics is not derived from fossilized biomass, but from atmospheric CO₂ absorbed by vegetal biomass, these plastics should alleviate the effects of climate change.

Because of their bicyclic constrained geometry and their oxygenated rings, 1,4:3,6-dianhydrohexitols can deliver advantageous features when incorporated into poly aryl ether sulfone structures. Also the innocuous character of the molecules opens the possibility of applications in packaging or medical devices, e.g., for hemodialysis membranes.

Depending on the chirality, three isomers of the 1,4:3,6-dianhydrohexitols sugar diol exist, namely isosorbide (1), isomannide (2) and isoidide (3):

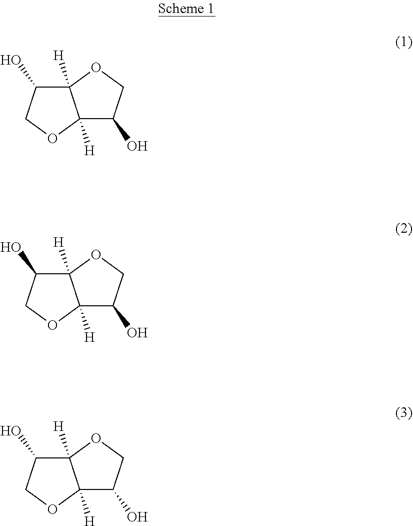 [SMILES: O[C@@H]1CO[C@H]2[C@@H]1OC[C@@H]2O ; O[C@@H]1CO[C@H]2[C@@H]1OC[C@H]2O ; O[C@H]1CO[C@H]2[C@@H]1OC[C@@H]2O]

The 1,4:3,6-dianhydrohexitols are composed of two cis-fused tetrahydrofuran rings, nearly planar and V-shaped with a 1200 angle between rings. The hydroxyl groups are situated at carbons 2 and 5 and positioned on either inside or outside the V-shaped molecule, as shown in Scheme 1. They are designated, respectively, as endo or exo. A summary of the manufacture of these 1,4:3,6-dianhydrohexitols can be found in US 2015/0011446A1 (SOLVAY SPECIALTY POLYMERS ITALY, SpA).

Kricheldorf et al. first reported the preparation and characterization of poly(ether sulfone)s containing isosorbide from silylated isosorbide and difluorodiphenylsulfone (DFDPS) in 1995 (H. Kricheldorf, M. Al Masri, J. Polymer Sci., Pt A: Polymer Chemistry, 1995, 33, 2667-2671). Since the silylation step adds significant cost, Kricheldorf and Chatti (High Performance Polymers, 2009, 21, 105-118) modified their polymerization conditions and reported that poly(ether sulfone)s containing isosorbide could be made from pure isosorbide and DFDPS. The highest apparent molecular weight polymer obtained had an inherent viscosity (IV) of 0.65 dL/g, said IV was measured according to following conditions: CH₂Cl₂/trifluoroacetic acid solution (9/1 v/v) at 20° C., 0.20 dL/g. The glass transition temperature of this polymer was reported as 245° C. No examples were described where the polymerization reaction with isosorbide was conducted with the less reactive dichlorodiphenylsulfone (DCDPS).

More recent developments have made available some polyethersulfones comprising isosorbide groups through simpler and more effective synthetic methods, thereby delivering materials of higher molecular weight through an approach which can be scaled up to industrial level. Hence, WO 2014/072473 (SOLVAY SPECIALTY POLYMERS USA, LLC) provides for an improved method of making poly(arylether sulfone) polymers from 1,4:3,6-dianhydrohexitol and certain dihaloaryl compounds which enables obtaining polymers having increased molecular weight. Polysulfone isosorbide materials described therein are taught as notably useful for the manufacture of membranes, although no specific example of the actual manufacture of membranes, and more specifically of hollow fiber membranes, is provided.

While a polysulfoneisosorbide made with bio-sourced and sustainable isosorbide is also regarded as an endocrine safe polymer, its manufacture requires the use of DFDPS (as opposed to DCDPS) to obtain high molecular weight polymer. However the DFDPS monomer is much more expensive than DCDPS and its use requires a manufacturing plant made with expensive metallurgy (e.g., with Hastalloy® alloy).

Therefore the present invention aims to address several challenges linked to process economics, use of biosourced monomer(s) and use of bisphenol monomer(s) which lessen the impact of endocrine disruption potential:
reducing the economic constraint of making a poly(ether sulfone) containing isosorbide, isoidide, and/or isomannide by using a more cost-effective halogenic sulfone monomer (like DCDPS) while still achieving reasonable molecular weight (e.g., >55 kDa) for the poly(ether sulfone); and
reducing or eliminating the endocrine disruption potential of existing poly(ether sulfone) materials—which are typically made from Bisphenol A (BPA) or Bisphenol S (BPS)—in order for their use in applications where contact with food, drugs, blood and/or water takes places, such as in membrane markets.

### SUMMARY

The present invention relates to a bio-based poly(arylether sulfone) copolymer (“copolymer b-PAES”) that is preferably BPA and BPS free. In other words the copolymer b-PAES preferably comprises sulfone recurring units derived from dihydroxy monomers which are distinct from BPS and BPA.

This copolymer b-PAES preferably should have no or reduced endocrine disruption potential compared to PAES polymers/co-polymers made from BPA or BPS.

Such copolymer b-PAES is characterized by having high molecular weights (M_{w}) and having excellent thermal stability, good hydrophilicity, high stiffness and strength, good toughness and attractive impact properties; allowing to provide similar or improved performance relative to current commercial PAES grades made from BPA or BPS for applications such as membranes, coatings, additive manufacturing and 3D printing. A good hydrophilicity is particularly advantageous in filtration applications, e.g., for reducing overpressure required for filtrating aqueous media.

This copolymer b-PAES comprises at least two sulfone recurring units derived from two distinct dihydroxy monomers: a bio-compatible and bio-based diol momoner and a bisphenol monomer distinct from BPS and BPA. The bisphenol monomer comprises a bisphenolic compound with at least one alkyl substituted-phenol group, said bisphenolic compound being distinct from BPS and BPA. The bisphenol monomer preferably comprises a bisphenol F derivative with both alkyl substituted-phenol groups, where bisphenol F (BPF) is 4,4′-dihydroxydiphenylmethane. The bisphenol monomer more preferably excludes BPF, BPA and/or BPS. In some alternate or additional embodiments, the bisphenol monomer excludes 4,4′-biphenol.

With the presence of the at least two different sulfone recurring units, the hydrophilicity of such copolymer b-PAES may be adjusted by varying the relative amounts of these different sulfone recurring units. For example, if it is desirable to increase the hydrophilicity of the copolymer b-PAES, then the amount of sulfone recurring units derived from the bio-based diol monomer can be increased relative to the other sulfone recurring unit derived from the dihydroxy bisphenol monomer distinct from BPS and BPA.

A first aspect of the present invention relates to a sulfone copolymer b-PAES, comprising:
a) recurring units (Rₐ) of formula (I):

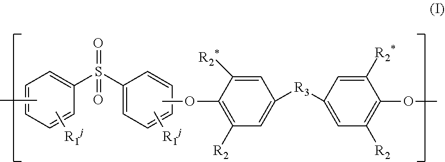

wherein:
each R₁ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j is zero or an integer of 1 to 4;
each R₂ is at each location independently selected from H or an alkyl having from 1 to 5 carbon atoms, preferably an alkyl having from 1 to 5 carbon atoms, preferably an alkyl having from 1 to 5 carbon atoms, more preferably methyl at each location,
each R₂* is at each location independently selected from an alkyl having from 1 to 5 carbon atoms, preferably methyl at each location; and
R₃ is represented by a cycloalkyl having from 5 to 8 carbon atoms or —CR^{p}R^{q}—, wherein each of R^{p} and R^{q} is independently selected from H, an alkyl having from 1 to 10 carbon atoms, an aromatic mono- or polynuclear group, or a cycloalkyl having from 5 to 8 carbon atoms, said aromatic mono- or polynuclear group or cycloalkyl being optionally substituted by at least one alkyl having from 1 to 10 carbon atoms; R₃ preferably being selected from —CH₂—, —C(CH₃)₂—,

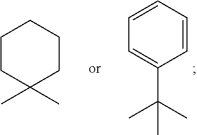

R₃ more preferably being selected from —CH₂— or —C(CH₃)₂—;
   and
b) recurring units (R_{b}) of formula (II) as shown below:

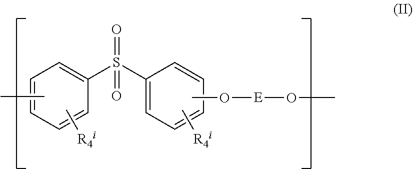

wherein:
each R₄ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
i is zero or an integer of 1 to 4, preferably R₄ and i in Formula (II) being the same as R₁ and j in Formula (I); and
each of E, equal to or different from each other and at each occurrence, is selected from the group consisting of those of formulae (E′-I) to (E′-III):

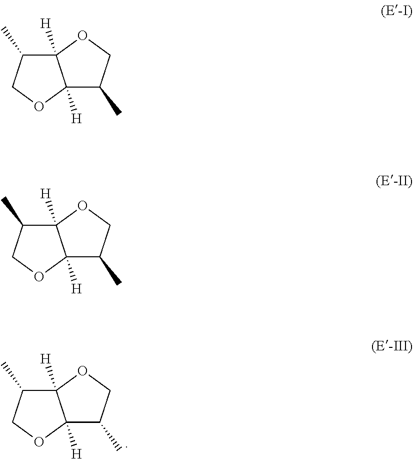

A second aspect of the present invention pertains to a process for manufacturing the copolymer b-PAES.

The process comprises reacting in a reaction mixture comprising a polar aprotic solvent and in the presence of an alkali metal carbonate, a monomers mixture comprising at least three different monomers.

The copolymer b-PAES is preferably derived from the condensation of the at least three different monomers.

The monomers mixture comprises:
at least one aromatic dihydroxy monomer [dihydroxy (AA), hereinafter], comprising at least a monomer of formula (A):

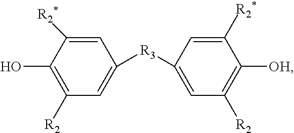

wherein
each R₂ is at each location independently selected from H or an alkyl having from 1 to 5 carbon atoms, preferably an alkyl having from 1 to 5 carbon atoms, more preferably methyl at each location;
each R₂* is at each location independently selected from an alkyl having from 1 to 5 carbon atoms, preferably methyl at each location; and
R₃ is represented by a cycloalkyl having from 5 to 8 carbon atoms or —CR^{p}R^{q}—, wherein each of R^{p} and R^{q} is independently selected from H, an alkyl having from 1 to 10 carbon atoms, an aromatic mono- or polynuclear group, or a cycloalkyl having from 5 to 8 carbon atoms, said aromatic mono- or polynuclear group or cycloalkyl being optionally substituted by at least one alkyl having from 1 to 10 carbon atoms; R₃ preferably being selected from —CH₂—, —C(CH₃)₂—,

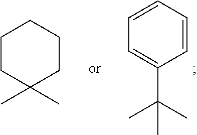

R₃ more preferably being selected from —CH₂— or —C(CH₃)₂—.
at least one 1,4:3,6-dianhydrohexitol [diol (BB), hereinafter] selected from the group consisting of isosorbide (1), isomannide (2) and isoidide (3), and
at least one dihaloaryl compound [dihalo (CC), hereinafter] of formula (C):

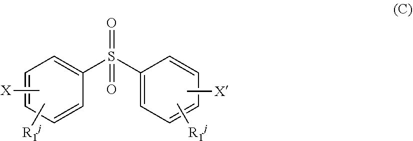

wherein:
each of R₁, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j is zero or is an integer from 0 to 4, preferably j=0; and
X and X′, equal to or different from each other, are independently a halogen atom, preferably Cl or F, more preferably Cl.

The molar ratio between the overall amount of hydroxyl groups and overall amount of halo groups in the monomers mixture is from 0.95 to 1.05, preferably from 0.98 to 1.02, more preferably from 0.99 to 1.01, most preferably 1.0, so as to obtain the copolymer b-PAES.

A third aspect of the present invention relates to the use of the copolymer b-PAES for the manufacture of articles such as membranes, coatings, films, fibers and sheets, and three-dimensional injected or molded or printed parts.

A fourth aspect of the present invention relates to shaped articles made from or comprising the copolymer b-PAES described herein, said shaped articles being selected from the group consisting of membranes, melt processed films, solution processed films, melt process monofilaments and fibers, solution processed monofilaments, hollow fibers and solid fibers, printed objects, coatings, and injection and compression molded objects, preferably membranes being selected from membranes for bioprocessing and medical filtrations (such as hemodialysis membranes), membranes for food and beverage processing, membranes for water purification, membranes for waste water treatment and membranes for industrial process separations involving aqueous media.

A further aspect of the present invention is a polymer solution for preparing a membrane, comprising the copolymer b-PAES in a polar organic solvent.

The various aspects, advantages, and features of the invention will be more readily understood and appreciated by reference to the detailed description and examples.

### Definitions

In the present descriptive specification, some terms are intended to have the following meanings.

As used herein, the term “total weight % polymer” is defined as the weight of the polymer to be obtained based on the monomers initially present in the monomers mixture at the end of the reaction.

The term “solvent” is used herein in its usual meaning, that is to say, it indicates a substance capable of dissolving another substance (solute) to form a uniformly dispersed mixture at the molecular level. In the case of a polymeric solute it is common practice to refer to a solution of the polymer in a solvent when the resulting mixture is transparent and no phase separation is visible in the system. Phase separation is taken to be the point, often referred to as “cloud point”, at which the solution becomes turbid or cloudy due to the formation of polymer aggregates.

As used herein, the acronym “BPA” means Bisphenol A or 4,4′-isopropylidenediphenol; the acronym “BPS” means Bisphenol S or 4,4′-dihydroxydiphenyl sulfone; and the acronym “BPF” means Bisphenol F or 4,4′-dihydroxydiphenylmethane.

As used herein and unless explicitly stated otherwise, “substantially free of” a component in a substance (such as reaction mixture, monomers mixture, a polymer, . . . ) means that the concentration of the component is no more than 1 wt. % or no more than 0.5 wt. % based on the total weight of such substance.

As used herein and unless explicitly stated otherwise, “free of” a component in a substance (such as reaction mixture, monomers mixture, a polymer, . . . ) means that the concentration of the component is no more than 0.1 wt. % or no more than 0.05 wt. %, based on the total weight of such substance.

For the purpose of the present invention, the expression “substantially all” in combination with a recited amount of recurring units is hereby intended to mean that minor amounts, generally below 1 mol %, preferably below 0.5 mol %, of other recurring units may be tolerated, e.g., as a result of lower purity in monomers used.

For the purpose of the present invention, the expression “substantially equimolecular” used with reference to the overall amount of dihydroxy (AA)/diol (BB) monomers and dihalo (CC) monomers in the monomers mixture is to be understood that the molar ratio between the overall amount of hydroxyl groups of the dihydroxy (AA)/diol (BB) monomers in the monomers mixture and overall amount of halogen groups of the dihalo (CC) monomers in the monomers mixture is from 0.95 to 1.05, preferably from 0.98 to 1.02, more preferably from 0.99 to 1.01, most preferably 1.0. The weight average molecular weight (M_{w}) can be estimated by gel-permeation chromatography (GPC)—also known as size exclusion chromatography—using ASTM D5296, calibrated with polystyrene standards and performed using methylene chloride as a mobile phase. The molecular weight (M_{w}) is defined as follows:

$${M}_{w} = \frac{\sum {M}_{i}^{2} \cdot {N}_{i}}{\sum {M}_{i} \cdot {M}_{i}}$$

wherein the summation is over all the chain lengths from 1 to ∞ and Nᵢ is the number of molecules whose weight is Mᵢ.

In the present specification, the choice of an element from a group of elements also explicitly describes:
the choice of two or the choice of several elements from the group,
the choice of an element from a subgroup of elements consisting of the group of elements from which one or more elements have been removed.

In the passages of the present specification which will follow, any description, even though described in relation to a specific embodiment, is applicable to and interchangeable with other embodiments of the present disclosure. Each embodiment thus defined may be combined with another embodiment, unless otherwise indicated or clearly incompatible. In addition, it should be understood that the elements and/or the characteristics of a composition, a product or article, a process or a use, described in the present specification, may be combined in all possible ways with the other elements and/or characteristics of the composition, product or article, process or use, explicitly or implicitly, this being done without departing from the scope of the present description.

In the present application, where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components. Any element or component recited in a list of elements or components may be omitted from such list. Further, it should be understood that elements, embodiments, and/or features of processes or methods described herein can be combined in a variety of ways without departing from the scope and disclosure of the present teaching, whether explicit or implicit herein.

In the present specification, the description of a range of values for a variable, defined by a bottom limit, or a top limit, or by a bottom limit and a top limit, also comprises the embodiments where the variable is chosen, respectively, within the range of values: excluding the bottom limit, or excluding the top limit, or excluding the bottom limit and the top limit. Any recitation herein of numerical ranges by endpoints includes all numbers subsumed within the recited ranges as well as the endpoints of the range and equivalents.

The term “comprising” (or “comprise”) includes “consisting essentially of” (or “consist essentially of”) and also “consisting of” (or “consist of”).

The use of the singular ‘a’ or ‘one’ herein includes the plural unless specifically stated otherwise.

The disclosure of all patent applications, and publications cited herein are hereby incorporated by reference, to the extent that they provide exemplary, procedural or other details supplementary to those set forth herein. Should the disclosure of any patents, patent applications, and publications which are incorporated herein by reference conflict with the description of the present application to the extent that it may render a term unclear, the present description shall take precedence.

### DETAILED DESCRIPTION OF PREFERRED EMBODIMENTS

The inventors have found that certain aromatic dihydroxy monomers which have low or no endocrine disruption potential and certain diols that originate from bio-based compounds can be used to successfully prepare a copolymer b-PAES with appropriate set of properties (notably molecular weight).

The copolymer b-PAES incorporating such monomers as well as articles comprising it or made therefrom (such as membranes to be used for purifying water or biological fluids) should exhibit low or reduced estrogenic activities compared to PAES polymers made from BPS or BPA, and therefore they should present lower risks for human health.

These bio-based copolymers b-PAES can also be effectively prepared using a less-expensive dihalo monomer (preferably DCDPS) thereby providing a more cost effective production. This is an improvement over previous PAES polymers made from diols originating from bio-based compounds which require the use of an expensive and more corrosive dihalo monomer: DFDPS, making scaling up of manufacturing plants a challenge in term of material of construction (e.g., Hasteloy® alloys) and also making the economics of such manufacturing plants less favorable due to higher operational costs.

Sulfone Copolymer b-PAES

The sulfone copolymer b-PAES according to preferred embodiments comprises, or consists essentially of, the recurring units (Rₐ) and (R_{b}) present in admixture.

The sulfone copolymer b-PAES may comprise
at least 20 mol %, or at least 30 mol %, or at least 40 mol %, or at least 50 mol %,
   or at least 60 mol %, or at least 70 mol % of recurring units (Rₐ) with respect to all the recurring units of copolymer b-PAES,
   and/or
at most 95 mol %, or at most 90 mol %, or at most 85 mol %, or at most 80 mol %, or at most 75 mol %, of recurring units (Rₐ) with respect to all the recurring units of copolymer b-PAES.

The sulfone copolymer b-PAES may comprise
at least 5 mol %, or at least 10 mol % of recurring units (R_{b}) with respect to all the recurring units of copolymer b-PAES
   and/or
at most 80 mol %, or at most 70 mol %, or at most 60 mol %, or at most 50 mol %, or at most 40 mol %, or at most 30 mol %, of recurring units (R_{b}) with respect to all the recurring units of copolymer b-PAES.

The sulfone copolymer b-PAES may comprise a molar ratio of the recurring units (R_{b}) to the recurring units (Rₐ) of at least 5:95, or at least 10:90 and/or at most 95:5, or at most 90:10, or at most 50:50, or at most 30:70, or at most 25:75.

In preferred embodiments, the copolymer b-PAES comprises recurring units (Rₐ) and (R_{b}) in an amount of more than 50% moles, preferably more than 60% moles, more preferably more than 75% moles, even more preferably more than 80% moles, yet even more preferably more than 90% or more than 95% moles, most preferably more than 98% or more than 99% moles, with respect to all the recurring units of copolymer b-PAES.

In more preferred embodiments, substantially all recurring units in the copolymer b-PAES are the recurring units (Rₐ) and (R_{b}).

The copolymer b-PAES is preferably BPA free and BPS free.

In more preferred embodiments, the copolymer b-PAES preferably excludes at least one recurring unit selected from recurring units of formulae (j), (jj), (jjj) and (jv), defined later in relation to optional units (Rₛ).

In additional or alternate embodiments, the copolymer b-PAES is BPF free.

This copolymer b-PAES should have no or reduced endocrine disruption potential compared to PAES polymers/co-polymers made from BPA or BPS or BPF.

With the presence of the at least two different sulfone recurring units (Rₐ) and (R_{b}), the hydrophilicity of such copolymer b-PAES may be adjusted by varying their relative amounts of recurring units (Rₐ) and (R_{b}) in copolymer b-PAES. For example, if it is desirable to increase the hydrophilicity of the copolymer b-PAES, then the amount of sulfone recurring units (R_{b}) derived from the bio-based diol momoner can be increased relative to the other sulfone recurring unit (Rₐ) derived from the dihydroxy bisphenol monomer distinct from BPS and BPA

### Recurring Units Rₐ

The recurring units (Rₐ) in copolymer b-PAES are of the formula (I), wherein:
each R₁ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j is zero or an integer of 1 to 4;
each R₂ is at each location independently selected from H or an alkyl having from 1 to 5 carbon atoms, preferably an alkyl having from 1 to 5 carbon atoms at each location, more preferably methyl at each location
each R₂* is at each location independently selected from an alkyl having from 1 to 5 carbon atoms, preferably methyl at each location, and
R₃ is represented by a cycloalkyl having from 5 to 8 carbon atoms or —CR^{p}R^{q}—, wherein each of R^{p} and R^{q} is independently selected from H, an alkyl having from 1 to 10 carbon atoms, an aromatic mono- or polynuclear group, or a cycloalkyl having from 5 to 8 carbon atoms, said aromatic mono- or polynuclear group or cycloalkyl being optionally substituted by at least one alkyl having from 1 to 10 carbon atoms; R₃ preferably being selected from —CH₂—, —C(CH₃)₂—,

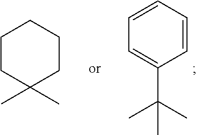

R₃ more preferably being selected from —CH₂— or —C(CH₃)₂—.

In preferred embodiments, the recurring units (Rₐ) are of formula (I*):

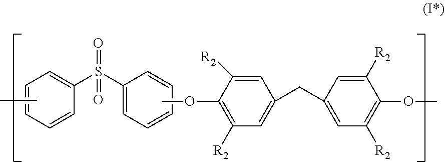

wherein each R₂ is at each location independently selected from an alkyl having from 1 to 5 carbon atoms, preferably a methyl group.

### Recurring Units R_{b}

The recurring units (R_{b}) in copolymer b-PAES are of the formula (II), wherein:
each R₄ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
i is zero or an integer of 1 to 4, and
each of E, equal to or different from each other and at each occurrence, is selected from the group consisting of those of formulae (E′-I) to (E′-III):
   for

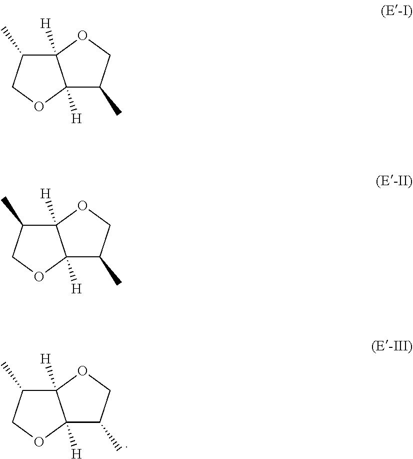

and any combinations thereof.

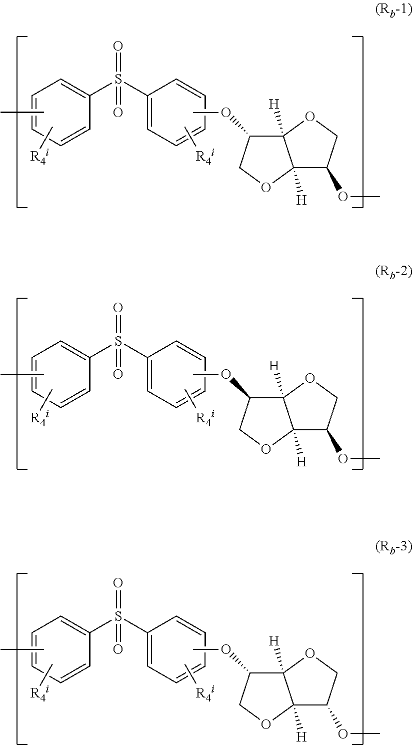

wherein R₄ and i have the same meaning as defined above in relation to Formula (II).

Preferably, R₄ and i in formulae (R_{b}-1), (R_{b}-2), (R_{b}-3) are the same as R₁ and j in Formula (I).

Preferably, i is equal to 0 in formulae (R_{b}-1), (R_{b}-2), and (R_{b}-3).

### Optional Recurring Units Rₛ

The copolymer b-PAES may comprise, in addition to recurring units (Rₐ) and (R_{b}), as detailed above, optional recurring units (R_{S}) comprising a Ar—SO₂—Ar′ group, with Ar and Ar′, equal to or different from each other, being aromatic groups, said recurring units (Rₛ) generally complying with formulae (S1):

—Ar⁵-(T-Ar⁶)ₙ—O—Ar⁷—SO₂—[Ar⁸-(T′-Ar⁹)ₙ—SO₂]ₘ—Ar¹⁰— (S1)

wherein:
Ar⁵, Ar⁶, Ar⁷, Ar⁸, and Ar⁹, equal to or different from each other and at each occurrence, are independently an aromatic mono- or polynuclear group;
T and T′, equal to or different from each other and at each occurrence, is independently a bond or a divalent group optionally comprising one or more than one heteroatom; preferably T and T′ are selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂— and a group of formula:

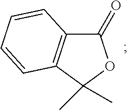

most preferably, T is a bond, —SO₂—, or —C(CH₃)₂— and T′ is a bond;
n and m, equal to or different from each other, are independently zero or an integer of 1 to 5.

Optional recurring units (R_{S}) can be notably selected from the group consisting of those of formulae (S-A) to (S-D) herein below:

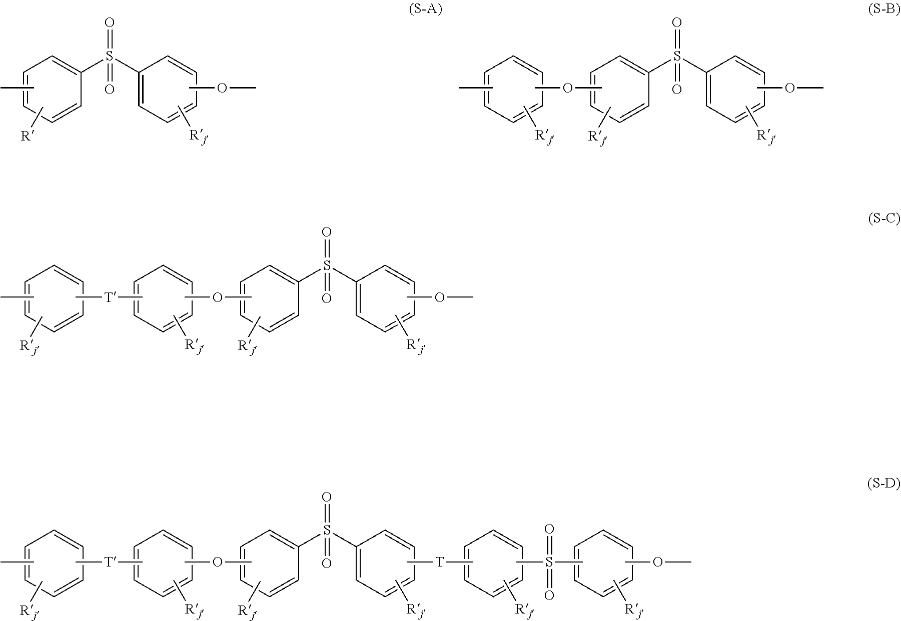

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4;
T and T′, equal to or different from each other are a bond or a divalent group optionally comprising one or more than one heteroatom; preferably T and T′ are selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

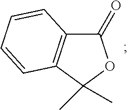

most preferably, T′ is a bond, —SO₂—, or —C(CH₃)₂— and T is a bond.
In optional recurring unit (R_{S}), the respective phenylene moieties may independently have 1,2-, 1,4- or 1,3-linkages to the other moieties different from R in the recurring unit. Preferably, said phenylene moieties have 1,3- or 1,4-linkages, more preferably they have 1,4-linkage. Still, in recurring units (R_{S}), j′ is at each occurrence zero, that is to say that the phenylene moieties have no other substituents than those enabling linkage in the main chain of the copolymer.

Recurring units (R_{S}) of formula (S-D) are preferably selected from the group consisting of the following recurring units:

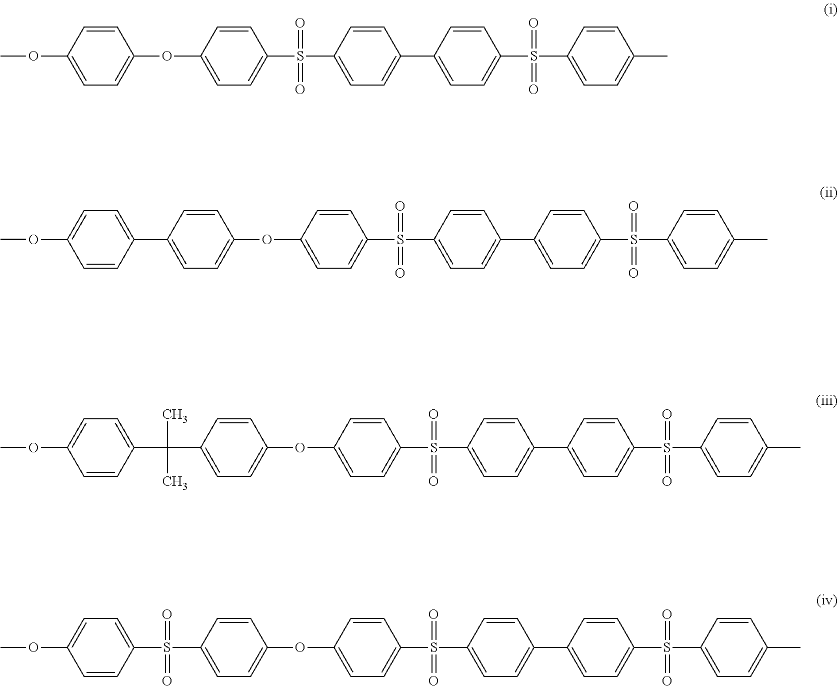

and mixtures thereof.

Optional recurring units (R_{S}) complying with formula (S-C), as above detailed, are preferably selected from the group consisting of the following units of formulae (j), (jj), (jjj) and (jv):

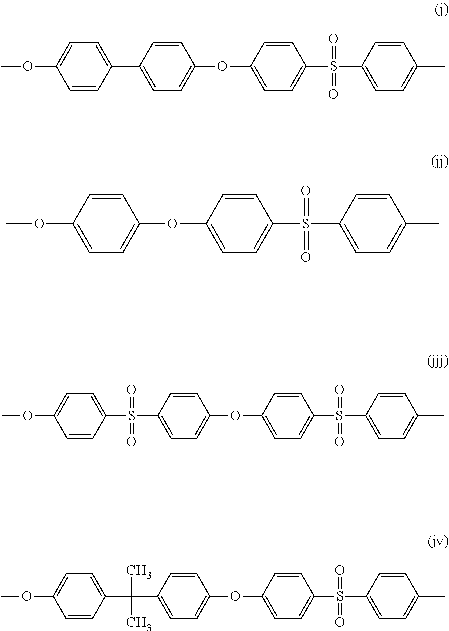

and mixtures thereof.

When recurring units different from units (Rₐ) and (R_{b}) are present in the copolymer b-PAES, the optional recurring units are generally selected from recurring units (R_{S}), as above below, so that the copolymer b-PAES consists essentially of recurring units (Rₐ) and (R_{b}), as above detailed, and, optionally, recurring units (R_{S}).

When at least one optional recurring unit (R_{S}) is present in the sulfone copolymer b-PAES, the sulfone copolymer b-PAES may comprise:
less than 30 mol %, or not more than 20 mol %, or not more than 10 mol %, or from 0.1 mol % to 10 mol %, or from 0.1 mol % to 5 mol %, or from 0.1 mol % to 2 mol %, or from 0.1 mol % to 1 mol % of recurring unit (Rₛ) with respect to all the recurring units of copolymer b-PAES. This is particularly applicable when the optional recurring unit (Rₛ) is at least one unit selected from units of formulae (j), (jj), (jjj) and (jv). End chains, defects, and minor amounts (<1% moles, with respect to all the recurring units of copolymer b-PAES) of recurring units other than recurring units (Rₐ), (R_{b}) and optional recurring units (R_{S}) when present, without their presence substantially affecting the properties of the copolymer b-PAES.

It is generally understood that good results can be achieved using a copolymer b-PAES wherein substantially all recurring units are the recurring units (Rₐ) and (R_{b}).

The copolymer b-PAES has in general a weight averaged molecular weight (M_{w}) of:
at least 50 kDa, or at least 60 kDa, or at least 70 kDa, and/or
at most 200 kDa, or at most 180 kDa, or at most 170 kDa, or at most 150 kDa, or at most 140 kDa, or at most 120 kDa, or at most 115 kDa, or at most 100 kDa, or at most 90 kDa.

The weight average molecular weight (M_{w}) can be estimated by gel-permeation chromatography (GPC) using ASTM D5296 calibrated with polystyrene standards and performed using methylene chloride as a mobile phase.

In preferred embodiments, the bio-based sulfone copolymer b-PAES comprises:
a) recurring units (Rₐ) of the formula (1*), wherein each R₂ is at each location independently selected from an alkyl having from 1 to 5 carbon atoms, preferably a methyl group, and
b) recurring units (R_{b}) have at least one formula selected from the group consisting of the formulae (R_{b}-1), (R_{b}-2), (R_{b}-3), and any combinations thereof, wherein i is equal to 0 in formulae (R_{b}-1), (R_{b}-2), and (R_{b}-3).

In most preferred embodiments, the bio-based sulfone copolymer b-PAES is made from the polycondensation of tetramethyl bisphenol F (TMBPF), isosorbide and 4,4′-dichlorodiphenylsulfone (DCDPS).

Process for Manufacturing the Copolymer b-PAES

The second aspect of the present invention relates to a process for manufacturing the copolymer b-PAES as described herein.

The manufacturing process comprises reacting in a reaction mixture (R_{G}) comprising a polar aprotic solvent and an alkali metal carbonate, a monomers mixture which contains at least 3 different monomers:
at least one aromatic dihydroxy monomer [dihydroxy (AA) monomer, hereinafter],
at least one 1,4:3,6-dianhydrohexitol monomer [diol (BB) monomer), hereinafter], and
at least one aromatic dihalo sulfone monomer [dihalo (CC) monomer, hereinafter].

The copolymer b-PAES described in the present disclosure is obtained from the condensation of at least these three different monomers (AA), (BB) and (CC).

The copolymer b-PAES described in the present disclosure is preferably obtained from the condensation of only these three different monomers (AA), (BB) and (CC).

In preferred embodiments, the molar ratio between the overall amount of hydroxyl groups and overall amount of halo groups in the monomers mixture is from 0.95 to 1.05, preferably from 0.98 to 1.02, more preferably from 0.99 to 1.01, most preferably 1.0, so as to obtain the copolymer b-PAES.

According to the condensation reaction, the components (monomers, polar aprotic solvent, alkali metal carbonate) of the reaction mixture (R_{G}) are generally reacted concurrently. The reaction is preferably conducted in one stage. This means that the deprotonation of dihydroxy (AA) and diol (BB) monomers and the condensation reaction between the dihydroxy (AA)+diol (BB) monomers and the dihalo (CC) monomer takes place in a single reaction stage without isolation of the intermediate products.

In preferred embodiments, the reaction mixture (R_{G}) is substantially free of 4,4′-dihydroxydiphenyl sulfone (BPS), i.e., contains less than 0.1 wt. % of BPS.

In preferred embodiments, the reaction mixture (R_{G}) is substantially free of 4,4′-isopropylidenediphenol (BPA), i.e., contains less than 0.1 wt. % of BPA.

In some embodiments, the reaction mixture (R_{G}) is substantially free of 4,4′-dihydroxydiphenylmethane or bisphenol F (BPF), i.e., contains less than 0.1 wt. % of BPF.

In other embodiments, the reaction mixture (R_{G}) excludes bisphenols A, S, and F.

In alternate embodiments when the reaction mixture (R_{G}) includes at least one of bisphenols A, S, F as additional dihydroxy (A′A′) monomer, the reaction mixture (R_{G}) contains not more than 10 mol %, or from 0.1 mol % to 10 mol %, or from 0.1 mol % to 5 mol %, or from 0.1 mol % to 2 mol %, or from 0.1 mol % to 1 mol %, of BPA, BPS or BPF based on the total amount of moles of dihydroxy (AA) monomer+diol (BB) monomer+such additional dihydroxy (A′A′) monomer.

In preferred embodiments, the reaction mixture (R_{G}) is substantially free of 4,4′-biphenol, i.e., contains less than 0.1 wt. % of 4,4′-biphenol.

In alternate embodiments when the reaction mixture (R_{G}) includes 4,4′-biphenol as additional dihydroxy (A′A′) monomer, the reaction mixture (R_{G}) contains not more than 10 mol %, or from 0.1 mol % to 10 mol %, or from 0.1 mol % to 5 mol %, or from 0.1 mol % to 2 mol %, or from 0.1 mol % to 1 mol %, of biphenol based on the total amount of moles of dihydroxy (AA) monomer+diol (BB) monomer+such additional dihydroxy (A′A′) monomer.

### Aromatic Dihydroxy (AA) Monomer

The aromatic dihydroxy (AA) monomer may comprise at least one bisphenol derivative, preferably comprises a bisphenolic compound with at least one substituted-phenol group, preferably with both substituted-phenol groups. Preferably, each of the two phenol groups in this bisphenolic compound is substituted in at least one location by an alkyl having from 1 to 5 carbon atoms, preferably substituted in at least one location with a methyl group. More preferably, each of the two phenol groups in the bisphenolic compound is substituted at two locations by an alkyl having from 1 to 5 carbon atoms, preferably substituted at two locations with a methyl group. Preferably, at least two locations (but not more than 3) of each of the two phenol groups in this bisphenolic compound is unsubstituted, i.e., the substituted-phenol bisphenolic compound has H at 2 (preferred) or 3 (less preferred) locations on each of the two phenol groups.

The dihydroxy (AA) monomer preferably comprises at least a monomer of the formula (A), wherein
each R₂ is at each location independently selected from H or an alkyl having from 1 to 5 carbon atoms, preferably an alkyl having from 1 to 5 carbon atoms, more preferably methyl at each location;
each R₂* is at each location independently selected from an alkyl having from 1 to 5 carbon atoms, preferably methyl at each location, and
R₃ is represented by a cycloalkyl having from 5 to 8 carbon atoms or —CR^{p}R^{q}—, wherein each of R^{p} and R^{q} is independently selected from H, an alkyl having from 1 to 10 carbon atoms, an aromatic mono- or polynuclear group, or a cycloalkyl having from 5 to 8 carbon atoms, said aromatic mono- or polynuclear group or cycloalkyl being optionally substituted by at least one alkyl having from 1 to 10 carbon atoms; R₃ preferably being selected from —CH₂—, —C(CH₃)₂—,

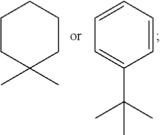

R₃ more preferably being selected from —CH₂— or —C(CH₃)₂—.

The dihydroxy (AA) monomer more preferably comprises at least a monomer of formula (A*):

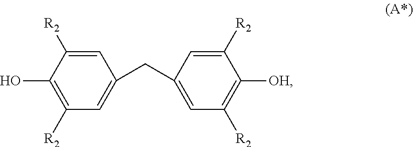

wherein each R₂ is at each location independently selected from an alkyl having from 1 to 5 carbon atoms, preferably methyl at each location.

According to an embodiment, the aromatic dihydroxy (AA) monomer comprises at least 50 mol. % of monomer of formula (A) or (A*), based on the total moles of aromatic dihydroxy (AA) monomer. For example at least 60 mol. %, or at least 70 mol. %, or at least 80 mol. %, or at least 90 mol. %, or at least 95 mol. %, or at least 99 mol. % of the aromatic dihydroxy (AA) monomer comprises monomer of formula (A) or (A*).

According to a preferred embodiment, the aromatic dihydroxy (AA) monomer consists essentially of monomer of formula (A) or (A*).

According to a most preferred embodiment, the aromatic dihydroxy (AA) monomer is tetramethyl bisphenol F (TMBPF).

### Bio-Based Diol (BB) Monomer

The bio-based diol (BB) monomer preferably comprises at least one diol selected from the group consisting of isosorbide (1), isomannide (2) and isoidide (3).

According to an embodiment, the diol (BB) monomer comprises at least 50 mol. % of at least one diol selected from the group consisting of isosorbide (1), isomannide (2) and isoidide (3), based on the total moles of diol (BB) monomer. For example at least 60 mol. %, or at least 70 mol. %, or at least 80 mol. %, or at least 90 mol. %, or at least 95 mol. %, or at least 99 mol. % of the diol (BB) monomer comprises at least one diol selected from the group consisting of isosorbide (1), isomannide (2) and isoidide (3).

According to a preferred embodiment, the diol (BB) monomer consists essentially of at least one diol selected from the group consisting of isosorbide (1), isomannide (2) and isoidide (3).

According to a more preferred embodiment, the diol (BB) monomer consists essentially of isosorbide (1) and optionally isomannide (2) and/or isoidide (3).

According to a most preferred embodiment, the diol (BB) monomer is isosorbide (1).

### Dihalo (CC) Sulfone Monomer

The aromatic dihalo (CC) sulfone monomer preferably comprises a dihalo of the formula (C) provided earlier, wherein:
each of R₁, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j is zero or is an integer from 0 to 4, preferably j=0; and
X and X′, equal to or different from each other, are independently a halogen atom, preferably Cl or F, more preferably Cl.

According to an embodiment, the aromatic dihalo (CC) sulfone monomer comprises at least 50 mol. % of a 4,4-dihalosulfone comprising at least one of a 4,4′-dichlorodiphenyl sulfone (DCDPS) or 4,4′ difluorodiphenyl sulfone (DFDPS), preferably DCDPS. For example at least 60 mol. %, or at least 70 mol. %, or at least 80 mol. %, or at least 90 mol. %, or at least 95 mol. %, or at least 99 mol. % of the aromatic dihalo (CC) sulfone monomer comprises 4,4-dihalosulfone.

According to an embodiment, the aromatic dihalo (CC) sulfone monomer comprises at least 50 mol. % of 4,4′-dichlorodiphenyl sulfone (DCDPS), based on the total moles of aromatic dihalo (CC) sulfone monomer. For example at least 60 mol. %, or at least 70 mol. %, or at least 80 mol. %, or at least 90 mol. %, or at least 95 mol. %, or at least 99 mol. % of the aromatic dihalo (CC) sulfone monomer comprises DCDPS.

According to a preferred embodiment, the aromatic dihalo (CC) sulfone monomer consists essentially of DCDPS.

In preferred embodiments, the molar ratio of the overall amounts of aromatic dihydroxy (AA) monomer+bio-based diol (BB) monomer over the overall amount of aromatic dihalo (CC) sulfone monomer in the monomers mixture is:
at least 0.95 to 1.05, or least 0.98, or at least 0.99 and/or
at most 1.05, or at most 1.02, or at most 1.01.

In more preferred embodiments, the molar ratio of the overall amounts of aromatic dihydroxy (AA) monomer+bio-based diol (BB) monomer over the overall amount of aromatic dihalo (CC) sulfone monomer in the monomers mixture is 1.0.

According to more preferred embodiments when the aromatic dihydroxy (AA) monomer consists essentially of monomer of formula (A); the diol (BB) monomer consists essentially of at least one diol selected from the group consisting of isosorbide (1), isomannide (2) and isoidide (3); and the aromatic dihalo (CC) sulfone monomer consists essentially of DCDPS, the molar ratio of the overall amounts of monomer of formula (A)+at least one diol selected from the group consisting of isosorbide (1), isomannide (2) and isoidide (3) over the overall amount of DCDPS in the monomers mixture is:
at least 0.95 to 1.05, or least 0.98, or at least 0.99 and/or
at most 1.05, or at most 1.02, or at most 1.01.

According to yet more preferred embodiments, the molar ratio of the overall amounts of monomer of formula (A)+at least one diol selected from the group consisting of isosorbide (1), isomannide (2) and isoidide (3) over the overall amount of DCDPS in the monomers mixture is 1.0.

In more preferred embodiments, the process for manufacturing the copolymer b-PAES comprises reacting in a reaction mixture (R_{G}) comprising a polar aprotic solvent and in the presence of an alkali metal carbonate, a monomers mixture comprising least three different monomers:
at least one aromatic dihydroxy monomer [dihydroxy (AA)], comprising at least a monomer of the formula (A*),
   wherein each R₂ is at each location independently selected from an alkyl having from 1 to 5 carbon atoms, preferably methyl at each location;
at least isosorbide of formula (1) as diol (BB),
at least 4,4′-dichlorodiphenyl sulfone (DCDPS) as dihalo (CC),
   wherein the molar ratio between the overall amount of hydroxyl groups and overall amount of halo groups in the monomers mixture is from 0.95 to 1.05, preferably from 0.98 to 1.02, more preferably from 0.99 to 1.01, most preferably 1.0, so as to obtain the copolymer b-PAES.

In most preferred embodiments, the process for manufacturing the copolymer b-PAES comprises reacting in a reaction mixture (R_{G}) comprising a polar aprotic solvent and in the presence of an alkali metal carbonate, a monomers mixture comprising (or consisting essentially of) three different monomers:
tetramethyl bisphenol F (TMBPF) as the aromatic dihydroxy (AA) monomer
isosorbide as the diol (BB) monomer, and
4,4′-dichlorodiphenylsulfone (DCDPS) as the dihalo (CC) monomer.

### Polar Aprotic Solvent

The polar aprotic solvent used in the reaction mixture to make the copolymer b-PAES described herein may be selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1, 1-dioxide (commonly called tetramethylene sulfone or sulfolane), N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and mixtures thereof; preferably selected from the group consisting of 1,3-dimethyl-2-imidazolidinone (DMI), N-Methyl-2-pyrrolidone (NMP), dimethylsulfoxide (DMSO), dimethylsulfone (DMSO2), N-butylpyrrolidinone (NBP), N-Ethylpyrrolidone (NEP), N,N′-dimethylacetamide (DMAc), N,N′-dimethylpropyleneurea (DMPU), dimethylformamide (DMF), and/or sulfolane.

### Alkali Metal Carbonate

The condensation process described herein may be carried out in the presence of a carbonate component which is selected in the group of alkali metal hydrogencarbonates, for example sodium hydrogencarbonate (NaHCO₃) and potassium hydrogencarbonate (KHCO₃), or in the group of alkali metal carbonate, for example rubidium carbonate, cesium carbonate, potassium carbonate (K₂CO₃) and/or sodium carbonate (Na₂CO₃).

Preferably the process of the present invention is carried out in the presence of potassium carbonate (K₂CO₃), sodium carbonate (Na₂CO₃) or a combination thereof.

According to an embodiment, the process of the present invention is carried out in the presence of a low particle size alkali metal carbonate, for example comprising anhydrous K₂CO₃, having a volume-averaged particle size of less than about 100 μm, for example less than 45 μm, less than 30 μm or less than 20 μm. According to a preferred embodiment, the process of the present invention is carried out in in the presence of a carbonate component comprising not less than 50 wt. % of K₂CO₃ having a volume-averaged particle size of less than about 100 μm, for example less than 45 μm, less than 30 μm or less than 20 μm, based on the overall weight of the base component in reaction mixture. The volume-averaged particle size of the carbonate used can for example be determined with a Mastersizer 2000 from Malvern on a suspension of the particles in chlorobenzene/sulfolane (60/40).

The amount of the alkali metal carbonate used, when expressed by the ratio of the equivalents of alkali metal (M) per equivalent of hydroxyl group (OH) [eq. (M)/eq. (OH)] is:
at least 1, or at least 1.05, or at least 1.1, or at least 1.15, or at least 1.2, or at least 1.25, or at least 1.3; and/or
at most 4, or at most 3.5, or at most 3, or at most 2.5, or at most 2.
   Optional Co-Solvent Forming Azeotrope with Water

According to an embodiment of the manufacturing process, the reaction mixture (R_{G}) to carry out the condensation may further comprise, in addition to the polar aprotic solvent, a co-solvent which forms an azeotrope with water.

The co-solvent which forms an azeotrope with water includes aromatic hydrocarbons such as benzene, toluene, xylene, ethylbenzene, chlorobenzene and the like. The co-solvent preferably comprises or consists of toluene or chlorobenzene. The azeotrope forming co-solvent and the polar aprotic solvent are used typically in a weight ratio of from about 1:10 to about 1:1, preferably from about 1:5 to about 1:1 in the reaction mixture (R_{G}).

Water is continuously removed from the reaction mixture as an azeotrope with the azeotrope forming co-solvent so that substantially anhydrous conditions are maintained during the polymerization. The azeotrope-forming co-solvent, for example, chlorobenzene, is removed from the reaction mixture, typically by distillation, after the water formed in the reaction is removed leaving the copolymer b-PAES dissolved in the polar aprotic solvent.

Preferably, the reaction mixture (R_{G}) does not comprise any substance which forms an azeotrope with water.

### Polycondensation Reaction Conditions

In some embodiments, the process to manufacture the copolymer b-PAES is such that the reaction conversion at least 95%.

The temperature of the reaction mixture (R_{G}) is kept at about 150° C. to about 350° C., preferably from about 200° C. to about 300° C., more preferably from about 200° C. to about 230° C., yet more preferably from about 200° C. to about 220° C., for about one to 15 hours, preferably from about 3 to about 9 hours.

The monomers in the reaction mixture (R_{G}) are polycondensed, within the temperature range, until the requisite degree of condensation is reached.

The polycondensation time can vary from 0.1 to 15 hours, preferably from 1 to 15 or from 3 to 9 hours or from 4 to 7 hours, depending on the nature of the starting monomers and on the selected reaction conditions.

The inorganic constituents, for example sodium chloride or potassium chloride or excess of base, can be removed, before or after isolation of the copolymer b-PAES, by suitable methods such as dissolving and filtering, screening or extracting.

According to an embodiment, the reacting (condensation) is preferably carried out so as to obtain, at the end of the reaction, a total wt % polymer concentration [total weight % polymer, hereinafter] with respect to the total weight of the reaction mixture:
of at least 10 wt %, or at least 20 wt %, or at least 25 wt % polymer, or at least 30 wt % polymer, and/or
of at most 60 wt %, or at most 50 wt %.

According to preferred embodiments, the amount of copolymer b-PAES at the end of the reaction (condensation) is at least 30 wt. % and at most 50 wt % based on the total weight of the copolymer b-PAES+the polar aprotic solvent.

At the end of the reaction, the copolymer b-PAES is separated from the other components (salts, base, . . . ) to obtain a copolymer b-PAES solution. Filtration can for example be used to separate the copolymer b-PAES from the other components. The copolymer b-PAES solution can then be used as such for step (b) or alternatively, the copolymer b-PAES can be recovered from the solvent, for example by coagulation or devolatilization of the solvent.

Use of the Copolymer b-PAES

Another aspect of the present invention provides the use of the copolymer b-PAES for the manufacture of articles such as membranes, coatings, films, fibers and sheets, and three-dimensional injected or molded or printed parts.

Another aspect of the present invention provides a method for manufacture of articles such as membranes, coatings, films, fibers and sheets, and three-dimensional injected or molded or printed parts, said method comprising using the copolymer b-PAES.

The printed parts may be made via additive manufacturing or 3D printing.

Article Manufactured from the Copolymer b-PAES

Another aspect of the present invention provides a shaped article comprising the copolymer b-PAES according to the present invention.

Shaped articles manufactured from the copolymer b-PAES may be selected from the group consisting of membranes; melt processed films, monofilaments and fibers; solution processed films (porous and non-porous films, including solution casted membranes, and membranes from solution spinning); solution processed monofilaments; melt process monofilaments and fibers; hollow fibers and solid fibers; coatings; printed objects, and injection and compression molded objects.

Shaped articles manufactured from the copolymer b-PAES preferably may be a membrane, or a part thereof, preferably being selected from membranes for bioprocessing and medical filtrations (such as hemodialysis membranes), membranes for food and beverage processing, membranes for water purification, membranes for waste water treatment and membranes for industrial process separations involving aqueous media.

Among membranes, the copolymer b-PAES according to the present invention is particularly suitable for manufacturing membranes intended for contact with aqueous media, including a biological fluid such as body fluid, particularly blood.

From an architectural perspective, membranes manufactured from the copolymer b-PAES as above detailed may be provided under the form of flat structures (e.g. films or sheets), corrugated structures (such as corrugated sheets), tubular structures, or hollow fibers; as per the pore size is concerned, full range of membranes (non-porous and porous, including for microfiltration, ultrafiltration, nanofiltration, and reverse osmosis) can be advantageously manufactured from the copolymer b-PAES; pore distribution can be isotropic or anisotropic.

Shaped articles manufactured from the copolymer b-PAES according to the present invention, can be, as above mentioned, under the form of films and sheets. These shaped articles are particularly useful as specialized optical films or sheets, and/or suitable for packaging.

Further, shaped articles manufactured from the copolymer b-PAES according to the present invention, can be three-dimensional molded parts, in particular transparent or coloured parts.

Among applications of use wherein such injection molded parts can be used, mention can be made of healthcare applications, in particular medical and dental applications, wherein shaped articles made from the copolymer b-PAES, according to the present invention, can advantageously be used for replacing metal, glass and other traditional materials in single-use and reusable instruments and devices.

The shaped article made from at least the copolymer b-PAES is preferably BPA and BPS free.

In additional or alternate embodiments, the shaped article made from at least the copolymer b-PAES is BPF free.

### Membrane (as Article)

A membrane made from the copolymer b-PAES may be used for purifying water or a biological fluid, preferably blood.

The membrane made from at least the copolymer b-PAES preferably is free of BPS and BPA (i.e., contains less than 0.1 wt. % of BPS and less than 0.1 wt. % of BPA).

In additional or alternate embodiments, the membrane preferably made from at least the copolymer b-PAES is BPF free (i.e., contains less than 0.1 wt. % of bisphenol F).

The term “membrane” is used herein in its usual meaning, that is to say it refers to a discrete, generally thin, interface that moderates the permeation of chemical species in contact with it. This interface may be molecularly homogeneous, that is, completely uniform in structure (dense membrane), or it may be chemically or physically heterogeneous, for example containing voids, holes or pores of finite dimensions (porous membrane).

According to the present invention, a membrane is typically a microporous membrane which can be characterized by its average pore diameter and porosity, i.e., the fraction of the total membrane that is porous.

The membrane of the present invention may have a gravimetric porosity (%) of 20 to 90% and comprises pores, wherein at least 90% by volume of the said pores has an average pore diameter of less than 5 μm. Gravimetric porosity of the membrane is defined as the volume of the pores divided by the total volume of the membrane.

Membranes having a uniform structure throughout their thickness are generally known as symmetrical membranes; membranes having pores which are not homogeneously distributed throughout their thickness are generally known as asymmetric membranes. Asymmetric membranes are characterized by a thin selective layer (0.1-1 μm thick) and a highly porous thick layer (100-200 μm thick) which acts as a support and has little effect on the separation characteristics of the membrane.

Membranes can be in the form of one or more flat sheets or in the form of tubes.

Tubular membranes are classified based on their dimensions in tubular membranes having a diameter greater than 3 mm; capillary membranes, having a diameter comprised between 0.5 mm and 3 mm; and hollow fibers having a diameter of less than 0.5 mm. Capillary membranes are otherwise referred to as hollow fibers.

Hollow fibers are particularly advantageous in applications where compact modules with high surface areas are required.

The membranes according to the present invention can be manufactured using any of the conventionally known membrane preparation methods, for example, by a solution casting or solution spinning method.

Preferably, the membranes according to the present invention are prepared by a phase inversion method occurring in the liquid phase, said method comprising the following steps:
(i) preparing a PAES polymer solution comprising the copolymer b-PAES described herein and a polar solvent,
(ii) processing said solution into a film;
(iii) contacting said film with a non-solvent bath.

The membrane of the present invention may comprise the copolymer b-PAES described herein in an amount of at least 1 wt. %, for example at least 5 wt. %, at least 10 wt. %, at least 15 wt. %, at least 20 wt. %, at least 25 wt. %, or at least 30 wt. %, based on the total weight of the membrane.

The membrane of the present invention may comprise the copolymer b-PAES described herein in an amount of more than 50 wt. %, for example more than 55 wt. %, more than 60 wt. %, more than 65 wt. %, more than 70 wt. %, more than 75 wt. %, more than 80 wt. %, more than 85 wt. %, more than 90 wt. %, more than 95 wt. % or more than 99 wt. %, based on the total weight of the membrane.

According to an embodiment, the membrane of the present invention may comprise the copolymer b-PAES described herein in an amount ranging from 1 to 99 wt. %, for example from 3 to 96 wt. %, from 6 to 92 wt. % or from 12 to 88 wt. %, based on the total weight of the membrane.

The membrane of the present invention may further comprise at least one polymer distinct form the copolymer b-PAES described herein, for example another sulfone polymer, e.g., polysulfone (PSU), polyethersulfone (PES), poly(biphenyl ether sulfone) (PPSU), or a polyphenylene sulfide (PPS), a poly(aryl ether ketone) (PAEK), e.g., a poly(ether ether ketone) (PEEK), a poly(ether ketone ketone) (PEKK), a poly(ether ketone) (PEK) or a copolymer of PEEK and poly(diphenyl ether ketone) (PEEK-PEDEK copolymer), polyetherimide (PEI), and/or polycarbonate (PC). The other polymeric ingredient can also be polyvinylpyrrolidone and/or polyethylene glycol.

The membrane may also further comprise at least one non-polymeric ingredient such as a solvent, a filler, a lubricant, a mold release, an antistatic agent, a flame retardant, an anti-fogging agent, a matting agent, a pigment, a dye and/or an optical brightener.

A suitable example of a method for forming a membrane from a polyaryl ether sulfone polymer is described in US2019/054429A1 (Solvay Specialty Polymers USA), incorporated herein by reference.

### Polymer Solution (SP) for Preparing a Membrane

An aspect of the present invention is directed to a polymer solution (SP) for preparing a membrane, which comprises the copolymer b-PAES in a polar organic solvent [solvent (S_{SP})].

The overall concentration of the copolymer b-PAES in the polymer solution (SP) is preferably at least 8 wt. %, more preferably at least 12 wt. %, based on the total weight of the polymer solution. Typically, the concentration of the copolymer b-PAES in the polymer solution does not exceed 50 wt. %; preferably, it does not exceed 40 wt. %; more preferably, it does not exceed 30 wt. %, based on the total weight of the polymer solution (SP).

Concentrations of the copolymer b-PAES ranging between 15 and 25 wt. %, and more preferably between 16 and 22% wt, with respect to the total weight of polymer solution (SP) have been found particularly advantageous.

The polymer solution (SP) may further comprise at least one additional polymer distinct form the copolymer b-PAES described herein, for example another sulfone polymer, e.g., polysulfone (PSU), polyethersulfone (PES), poly(biphynyl ether sulfone) (PPSU), or a polyphenylene sulfide (PPS), a poly(aryl ether ketone) (PAEK), e.g., a poly(ether ether ketone) (PEEK), a poly(ether ketone ketone) (PEKK), a poly(ether ketone) (PEK) or a copolymer of PEEK and poly(diphenyl ether ketone) (PEEK-PEDEK copolymer), a polyetherimide (PEI), and/or a polycarbonate (PC). The other polymeric ingredient can also include or be polyvinylpyrrolidone and/or polyethylene glycol.

In such instances, the concentration of the at least one additional polymer and the copolymer b-PAES in the polymer solution (SP) does not exceed 50 wt. %; preferably, it does not exceed 40 wt. %; more preferably, it does not exceed 30 wt. %, based on the total weight of the polymer solution (SP).

The overall concentration of the solvent (S_{SP}) in the polymer solution (SP) may be at least 20 wt. %, preferably at least 30 wt. %, based on the total weight of the polymer solution. Typically the concentration of the solvent (S_{SP}) in the polymer solution (SP) does not exceed 70 wt. %; preferably, it does not exceed 65 wt. %; more preferably, it does not exceed 60 wt. %, based on the total weight of the polymer solution.

The solvent (S_{SP}) may be selected from a group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1, 1-dioxide (commonly called tetramethylene sulfone or sulfolane), N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and mixtures thereof.

Exemplary solvents (S_{SP}) which may be used, alone or in combination, in the polymer solution (SP) are described in patent applications in US2019054429A1 (Solvay Specialty Polymers Italy), in particular solvents described in paragraphs [0057]-[0129], and WO 2019/048652 (Solvay Specialty Polymers USA), incorporated herein by reference.

The polymer solution (SP) may contain additional components, such as nucleating agents, fillers and the like.

The polymer solution (SP) may also contain pore forming agents, notably polyvinylpyrrolidone (PVP), and polyethyleneglycol (PEG) having a molecular weight of at least 200.

### Purification Method for a Biological Fluid

A further aspect of the present invention may be directed to a purification method comprises at least a filtration step through the membrane described herein.

Preferably, the purification method is for purifying a human biological fluid, preferably a blood product, such as whole blood, plasma, fractionated blood components or mixtures thereof, that are carried out in an extracorporeal circuit. The extracorporeal circuit for carrying out a method comprises at least one filtering device (or filter) comprising at least one membrane as described above.

As intended herein, a blood purification method through an extracorporeal circuit comprises hemodialysis (FD) by diffusion, hemofiltration (HF), hemodyafiltration (HDF) and hemoconcentration. In HF, blood is filtered by ultrafiltration, while in HDF blood is filtered by a combination of FD and HF.

Blood purification methods through an extracorporeal circuit are typically carried out by means of a hemodialyzer, i.e. equipment designed to implement any one of FD, HF or HFD. In such methods, blood is filtered from waste solutes and fluids, like urea, potassium, creatinine and uric acid, thereby providing waste solutes- and fluids-free blood.

Typically, a hemodialyzer for carrying out a blood purification method comprises a cylindrical bundle of hollow fibers of membranes, said bundle having two ends, each of them being anchored into a so-called potting compound, which is usually a polymeric material acting as a glue which keeps the bundle ends together. Potting compounds are known in the art and include notably polyurethanes. By applying a pressure gradient, blood is pumped through the bundle of membranes via the blood ports and the filtration product (the “dialysate”) is pumped through the space surrounding the filers.

### EXAMPLES

The invention will be now described in more details with reference to the following examples, whose purpose is merely illustrative and not intended to limit the scope of the invention.

General Description of the Preparation of the Copolymer b-PAES

To a 1-liter resin flask (reactor) equipped with an overhead mechanical agitator, a nitrogen dip-tube, dean-stark trap with reflux condenser are charged tetramethylbisphenol F (TMBPF) as dihydroxy (AA) momoner, isosorbide as diol (BB) momoner, 4,4′-dichlorodiphenyl sulfone (DCDPS) as dihalo (CC) sulfone momoner, and potassium carbonate followed by the polar aprotic solvent (e.g., sulfolane or dimethylsulfoxide (DMSO2)) to form the monomers mixture.

The amounts of the monomers are selected so as to achieve a weight % polymer of from 30 to 50 wt % polymer in the reaction mixture.

The amount of potassium carbonate used in the monomers mixture, when expressed by the ratio of the equivalents of alkali metal (M) per equivalent of hydroxyl group (OH) [eq. (M)/eq. (OH)] is generally from 1.2 to 2 eq. (K)/eq. (OH).

The molar ratio in the monomers mixture between the overall amount of hydroxyl groups from TMBPF and isosorbide [(AA)+(BB) monomers] and the overall amount of halo groups from DCDPS monomer [(CC) monomer)] is about 1.0.

Before starting heat via external oil bath with a target internal reaction temperature (generally from 200 to 220° C.), nitrogen flow is established and the mixture is purged with nitrogen for 15 minutes. The reaction mixture comprising the monomers is stirred with the overhead mechanical agitator and warmed to initiate reaction using an oil bath controlled at the target internal reaction temperature. The bath temperature increased from 21° C. to the appropriate reaction temperature over about 30-60 minutes. Water, a byproduct of the polymerization reaction, is continuously stripped out of the reactor and collected in the dean-stark trap. Upon reaching the target internal temperature, the reaction is held at that temperature for a period of reaction time suitable until a desired M_{w} is achieved. The reaction time period may vary from 3 to 15 hours, and is generally from about 3 to 9 hours.

Once the desired molecular weight is achieved, the polymerization is terminated by bubbling gaseous methyl chloride through the reaction mixture at a rate of 1 g/min over 30-60 minutes. Because the mixture becomes viscous and difficult to stir at the end of the reaction, the reaction mixture is diluted with NMP to obtain 10% by weight in polymer and cooled to <100° C. The dilute polymer solution is filtered through a 2.7 μm glass fiber filter pad under pressure to remove salts. The polymer solution is poured in to a Waring blender containing a non-solvent (methanol or 50/50 vol./vol. methanol/acetone) and precipitate, using a ratio of 1:5 polymer solution to non-solvent to obtain a white solid. The isolated white solid is then washed with the same non-solvent 6 times with filtration between each wash, then vacuum filtered, and dried for 12 h in a vacuum oven at 120° C. The molecular weight M_{w} was measured by GPC.

### Determination of Molecular Weight

Size Exclusion Chromatography (SEC) was performed using Methylene Chloride as a mobile phase. Two 5 μm mixed D Size Exclusion Chromatography (SEC) columns with guard column from Agilent Technologies was used for separation. An ultraviolet detector of 254 nm is used to obtain the chromatogram. A flow rate of 1.5 ml/min and injection volume of 20 μL of a 0.2% w/v solution in mobile phase was selected. Calibration was performed using 10 narrow calibration standards of Polystyrene obtained from Agilent Technologies (Peak molecular weight range: 371000 to 580).

### Calibration Curve:

1) Type: Relative, Narrow calibration standard calibration
2) Fit: 3rd order regression.
   Integration and calculation: Empower Pro GPC software manufactured by Waters used to acquire data, calibration and molecular weight calculation. Peak integration start and end points are manually determined from significant difference on global baseline.

TABLE 1
Sources of reaction (condensation) components

| Chemicals | Sources |
|---|---|
| tetramethylbisphenol F (TMBPF) | TCI America |
| Isosorbide (ISO) | Roquette |
| 4,4′-dichlorodiphenyl sulfone (DCDPS) | Solvay Specialty Polymers USA |
| potassium carbonate | Aldrich |
| sulfolane | Aldrich |
| dimethylsulfoxide (DMSOc) | Aldrich |

### Examples 1-4:90 Mol % TMBPF & 10 Mol % Isosorbide Using Sulfolane as Solvent

The (b-PAES) of Example 1 was made according to the general procedure described above. The initial reaction mixture comprised:
103.822 g (0.405 mol) of tetramethylbisphenol F as dihydroxy (AA),
6.576 g (0.045 mol) of isosorbide “ISO” as diol (BB),
129.223 g (0.45 mol) of DCDPS as dihalo (CC),
93.288 g (0.675 mol) of anhydrous K₂CO₃ as alkali metal carbonate,
482.538 g sulfolane as solvent.

The molar ratio of [dihydroxy (AA)+diol (BB)]/dihalo (CC) was 1.

The molar % isosorbide based on the total number of moles of isosorbide+TMBPF was 10 mol %. The molar ratio eq. (K)/eq. (OH) was 1.5. The wt % polymer in the reaction mixture was 30 wt %. The targeted reaction temperature was 215° C. The reaction time was 5.75 hours.

Three other (b-PAES) of Examples 2-4 were made according to the same procedure as described in Example 1 with the molar ratio of [dihydroxy (AA)+diol (BB)]/dihalo (CC)=1 and a 30 wt % polymer in the reaction mixture, except that
the molar ratio eq. (K)/eq. (OH) varied from 1.2 to 1.5;
the targeted reaction temperature was 200° C. and
the reaction time was from 7.8 to 9 hours.
   The reaction conditions and the molecular weight M_{w} measured by GPC are shown in Table 2.

### Examples 5-11:75 Mol % TMBPF & 25 Mol % Isosorbide Using Sulfolane as Solvent

Three copolymers (b-PAES) of Examples 5-11 were made according to the same procedure as described in Example 1 with the molar ratio of [dihydroxy (AA)+diol (BB)]/dihalo (CC)=1 except that:
the molar % isosorbide based on the total number of moles of isosorbide+TMBPF was 25 mol %;
the wt % polymer in the reaction mixture was 40, 45 or 50 wt %,
the molar ratio eq. (K)/eq. (OH) varied from 1.5 to 2;
the targeted reaction temperature was 215 or 220° C.; and
the reaction time was from 3 to 6.5 hours.

The reaction conditions and the molecular weight measured by GPC are shown in Table 2.

### Example 12: 75 Mol % TMBPF & 25 Mol % Isosorbide Using Sulfolane as Solvent

The copolymer b-PAES of Example 12 was made according to the general procedure described above except that because the reaction mixture became quite viscous, the reaction mixture was diluted with 60.86 g sulfolane during reaction, and the viscosity was allowed to further increase. A sample of the reaction mixture was collected after about 5 hours at reaction temperature for M_{w} determination and the reaction was terminated without work-up.

The initial reaction mixture comprised:
86.518 g (0.338 mol) of tetramethylbisphenol F as dihydroxy (AA),
16.441 g (0.113 mol) of isosorbide “ISO” as diol (BB),
129.223 g (0.450 mol) of DCDPS as dihalo (CC),
108.870 g (0.788 mol) of anhydrous K₂CO₃ as alkali metal carbonate,
482.538 g sulfolane sulfolane as solvent.
   The molar ratio of [dihydroxy (AA)+diol (BB)]/dihalo (CC) was 1. The molar ratio eq. (K)/eq. (OH) was 1.75. The wt % polymer in the reaction mixture was 45 wt %. The targeted reaction temperature was 220° C.

The reaction conditions and the molecular weight M_{w} measured by GPC are shown in Table 2.

TABLE 2

| | mol | wt % | Eq. | Reaction | Reaction | |
|---|---|---|---|---|---|---|
| | % | poly- | K/Eq. | Temp. | time | M_{w} |
| Ex. | ISO | mer | OH | (° C.) | (hr:min) | (kDa) |
| 1 | 10% | 30% | 1.5 | 215 | 5:45 | 85 |
| 2 | 10% | 30% | 1.2 | 200 | 9:00 | 112 |
| 3 | 10% | 30% | 1.3 | 200 | 8:17 | 78 |
| 4 | 10% | 30% | 1.5 | 200 | 7:49 | 84 |
| 5 | 25% | 40% | 2.0 | 215 | 5:06 | 62 |
| 6 | 25% | 40% | 2.0 | 220 | 4:25 | 69 |
| 7 | 25% | 50% | 2.0 | 220 | 3:11 | 59 |
| 8 | 25% | 40% | 1.75 | 220 | 6:31 | 72 |
| 9 | 25% | 45% | 1.75 | 220 | 6:09 | 80 |
| 10 | 25% | 45% | 1.5 | 220 | 6:07 | 72 |
| 11 | 25% | 45% | 1.75 | 220 | 5:09 | 138 |
| 12 | 25% | 45% | 1.75 | 220 | 7:03 | 89 |

### Example 13: 75 Mol % TMBPF & 25 Mol % Isosorbide Using DMSO2 as Solvent

The copolymer b-PAES of Example 13 was made according to the procedure described for Example 11 except that dimethyl sulfone was used as solvent and a sample of the reaction mixture (without solvent dilution) was collected after about 3 hours at temperature for M_{w} determination and the reaction was terminated without work-up.

The initial reaction mixture comprised:
86.518 g (0.338 mol) of tetramethylbisphenol F as dihydroxy (AA),
16.441 g (0.113 mol) of isosorbide (ISO) as diol (BB),
129.223 g (0.450 mol) of DCDPS as dihalo (CC),
77.74 g (0.563 mol) of anhydrous K₂CO₃ as alkali metal carbonate,
243.667 g of Dimethylsulfone (DMSO2) as solvent.
   The molecular weight M_{w} measured by GPC was 79 kDa.

### Comparative Example 14: 100 Mol % TMBPF Using Sulfolane as Solvent

For comparative purposes, a TMBPF homopolymer was prepared using the following method. To a 1-L resin flask equipped with an overhead agitator, a nitrogen dip-tube, dean-stark trap with reflux condenser was charged 115.358 g (0.450 mol) of Tetramethylbisphenol F, 129.223 g (0.450 mol) of DCPDS, 65.302 g (0.473 mol) of K₂CO₃ and 494.11 g sulfolane. Agitation and nitrogen flow were established and the reaction mixture was purged with nitrogen for 15 minutes before starting heat via external oil bath with a target internal temperature of 200° C. Water, a byproduct of the polymerization reaction, was continuously stripped out of the reactor and collected in the dean-stark trap. Upon reaching 200° C., the reaction was held at that temperature until the desired Mw was achieved. Once desired molecular weight was achieved the polymerization was terminated by bubbling gaseous methylchloride through the reaction mixture at a rate of 1 g/min over 30-60 minutes. The reaction mixture was diluted with 317.64 g of sulfolane. The dilute polymer solution was filtered through a 2.7 μm glass fiber filter pad under pressure to remove salts. The polymer solution was precipitated in methanol or methanol/acetone (1:1) a ratio of 1:5 polymer solution to non-solvent to afford a white solid. The isolated white solid was then washed with the same non-solvent 6 times, vacuum filtered, and dried for 12 h in a vacuum oven at 100° C.

The molecular weight M_{w} measured by GPC was 78 kDa.

### Example 15—Preparation of Dense Polymer Films Sample & Contact Angle Measurement

Solutions of (20 wt. %) copolymer b-PAES of Examples 4 and 11 in DMAc (solvent from Sigma Aldrich) were prepared by stirring with a mechanical anchor for several hours at room temperature.

Flat dense polymeric films were prepared by casting each polymeric solution containing the copolymer b-PAES of Example 4 or 11 and the solvent over a suitable smooth glass support by means of an automatized casting knife at 40° C. The knife gap was set at 500 μm. After casting the films, the solvent was left to evaporate in a vacuum oven at 130° C. for 4 hours.

For comparison, films of commercial polysulfone (PSU), namely UDEL® P3500NT polysulfone supplied by Solvay, of commercial polyethersulfone (PES), namely Veradel® PES 3000MP supplied by Solvay, and of TMBPF homopolymer (Example 14) were prepared in the same way.

These films were used for contact angle measurements. The contact angles towards water on dense films were evaluated at 25° C. by using the Contact Angle System OCA Dataphysics according to ASTM D 5725-99. Values are average of at least 10 measurements. Volume drop was 2 microliters.

Results are summarized in Table 3.

The copolymers b-PAES from Examples 4 and 11 (according to the invention) were found to be more hydrophilic than the TMBPF homopolymer from Example 14 (not according to the invention) due to the incorporation of isosorbide in the polymer structure.

TABLE 3

| | Water contact angle | |
|---|---|---|
| Composition | Degree | Std Dev. |
| Copolymer b-PAES (Ex. 4) with 10% ISO | 87 | 3 |
| Copolymer b-PAES (Ex. 12) with 25% ISO | 92 | 3 |
| TMBPF homopolymer (Comparative Ex. 14) | 101 | 2 |
| Udel ® PSU P3500NT | 96 | 2 |
| Veradel ® PES 3000MP | 81 | 6 |

The copolymer b-PAES were also found to be more hydrophilic than the commercial polysulfone (PSU) and approaching that of the commercial polyethersulfone (PES).

Therefore the use of two distinct dihydroxy monomers: isosorbide (a bio-compatible and bio-based diol momoner) and TMBPF (a bisphenol monomer distinct from BPS and BPA) enabled a tuning of the hydrophilicity of the resulting copolymer b-PAES in order to achieve a hydrophilicity similar to PSU polymers comprising sulfone recurring units derived from BPA and to PES polymers comprising sulfone recurring units derived from BPS.

While preferred embodiments of this invention have been shown and described, modifications thereof can be made by one skilled in the art without departing from the spirit or teaching of this invention. The embodiments described herein are exemplary only and are not limiting. Many variations and modifications of systems and methods are possible and are within the scope of the invention. Accordingly, the scope of protection is not limited by the description set out above, but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention.

1. A bio-based sulfone copolymer b-PAES, comprising:
a) recurring units (Rₐ) of formula (I): 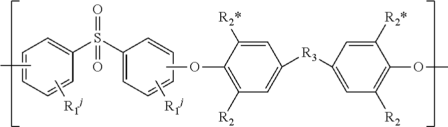
wherein:
each R₁ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j is zero or an integer of 1 to 4;
each R₂ is at each location independently selected from H or an alkyl having from 1 to 5 carbon atoms, preferably an alkyl having from 1 to 5 carbon atoms,
each R₂* is at each location independently selected from an alkyl having from 1 to 5 carbon atoms, and
R₃ is represented by a cycloalkyl having from 5 to 8 carbon atoms or —CR^{p}R^{q}—, wherein each of R^{p} and R^{q} is independently selected from H, an alkyl having from 1 to 10 carbon atoms, an aromatic mono- or polynuclear group, or a cycloalkyl having from 5 to 8 carbon atoms, said aromatic mono- or polynuclear group or cycloalkyl being optionally substituted by at least one alkyl having from 1 to 10 carbon atoms;
b) recurring units (R_{b}) of formula (II) as shown below: 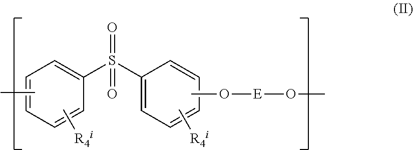
wherein
each R₄ is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
i is zero or an integer of 1 to 4; and
each of E, equal to or different from each other and at each occurrence, is selected from the group consisting of those of formulae (E′-I) to (E′-III):

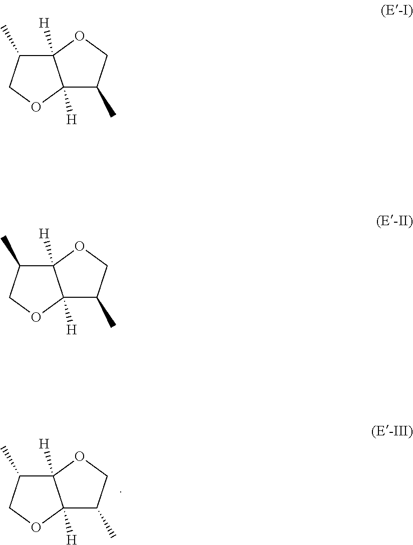

2. The bio-based sulfone copolymer b-PAES of claim 1, comprising
at least 5 mol % of the recurring units (Rb) with respect to all the recurring units of the copolymer b-PAES,
and/or
at most 80 mol % of the recurring units (Rb) with respect to all the recurring units of the copolymer b-PAES.

3. The bio-based sulfone copolymer b-PAES of claim 1, comprising
at least 20 mol % of the recurring units (Ra) with respect to all the recurring units of the copolymer b-PAES,
and/or
at most 95 mol % of the recurring units (Ra) with respect to all the recurring units of the copolymer b-PAES.

4. The bio-based sulfone copolymer b-PAES of claim 1, comprising a molar ratio of the recurring units (Rb) to the recurring units (Ra) of at least 5:95, and/or at most 95:5.

5. The bio-based sulfone copolymer b-PAES of claim 1, wherein the recurring units (R_{b}) are of formula selected from the group consisting of formulae (R_{b}-1), (R_{b}-2), (R_{b}-3), and any combinations thereof: 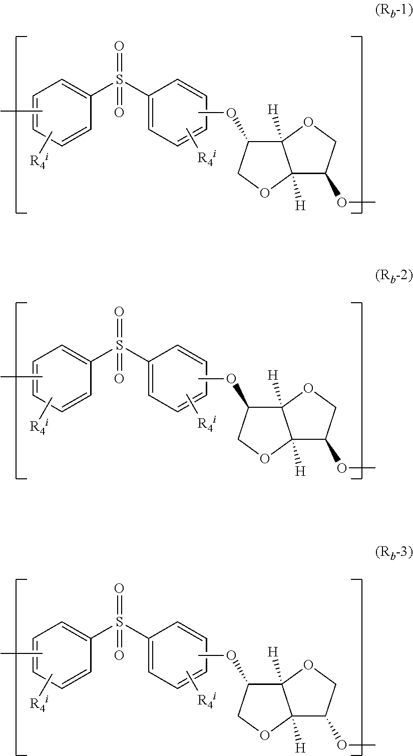
wherein R₄ and i have the same meaning as defined in claim 1.

6. The bio-based sulfone copolymer b-PAES of claim 1, wherein the recurring units (Rₐ) are of formula (I*): 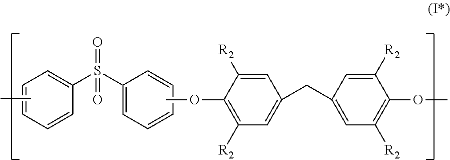
wherein each R₂ is at each location independently selected from an alkyl having from 1 to 5 carbon atoms.

7. The bio-based sulfone copolymer b-PAES of claim 1, having a weight averaged molecular weight (M_{w}) of
at least 50 kDa, and/or
at most 200 kDa.

8. A process for manufacturing the bio-based sulfone copolymer b-PAES of claim 1, comprising reacting in a reaction mixture comprising a polar aprotic solvent and in the presence of an alkali metal carbonate, a monomers mixture which contains:
at least one aromatic dihydroxy monomer [dihydroxy (AA), hereinafter], comprising at least a monomer of formula (A): 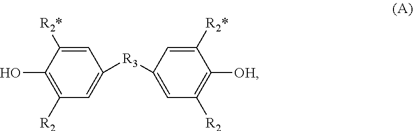
wherein
each R₂ is at each location independently selected from H or an alkyl having from 1 to 5 carbon atoms, preferably an alkyl having from 1 to 5 carbon atoms;
each R₂* is at each location independently selected from an alkyl having from 1 to 5 carbon atoms, and
R₃ is represented by a cycloalkyl having from 5 to 8 carbon atoms or —CR^{p}R^{q}—, wherein each of R^{p} and R^{q} is independently selected from H, an alkyl having from 1 to 10 carbon atoms, an aromatic mono- or polynuclear group, or a cycloalkyl having from 5 to 8 carbon atoms, said aromatic mono- or polynuclear group or cycloalkyl being optionally substituted by at least one alkyl having from 1 to 10 carbon atoms; and
at least one 1,4:3,6-dianhydrohexitol [diol (BB), hereinafter] selected from the group consisting of isosorbide (1), isomannide (2) and isoidide (3) 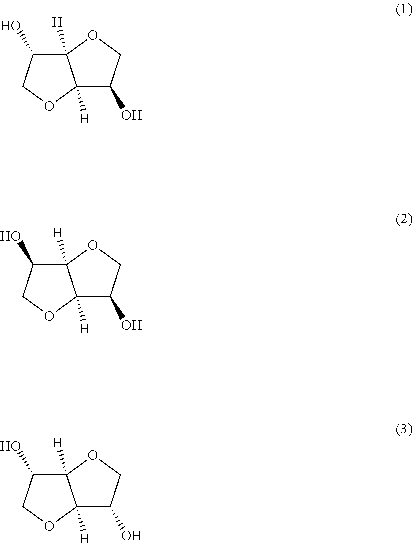 [SMILES: O[C@@H]1CO[C@H]2[C@@H]1OC[C@@H]2O ; O[C@@H]1CO[C@H]2[C@@H]1OC[C@H]2O ; O[C@H]1CO[C@H]2[C@@H]1OC[C@@H]2O]
at least one dihaloaryl compound [dihalo (CC), hereinafter] of formula (C): 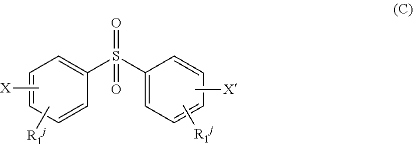
wherein
each of R₁, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j is zero or is an integer from 0 to 4; and
X and X′, equal to or different from each other, are independently a halogen atom,
wherein the molar ratio between the overall amount of hydroxyl groups and overall amount of halo groups in the monomers mixture is from 0.95 to 1.05, so as to obtain the copolymer b-PAES.

9. The process according to claim 7, wherein the polar aprotic solvents is selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1,1-dioxide (commonly called tetramethylene sulfone or sulfolane), N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and mixtures thereof.

10. The process according to claim 8, wherein the reaction is carried out so as to obtain a total wt % polymer concentration with respect to the total weight of the reaction mixture:
of at least 10 wt % polymer,
and/or
of at most 60 wt % polymer.

11. The process according to claim 8,
wherein the alkali metal carbonate is selected from a group consisting of sodium carbonate, potassium carbonate, rubidium carbonate and cesium carbonate.

12. The process according to claim 8, wherein the amount of the alkali metal carbonate used, when expressed by the ratio of the equivalents of alkali metal (M) per equivalent of hydroxyl group (OH) [eq. (M)/eq. (OH)] is:
at least 1; and/or
at most 4.

13. A method for the manufacture of membranes, coatings, films and sheets, and three-dimensional molded parts, comprising using the copolymer b-PAES of claim 1.

14. A polymer solution (SP) for preparing a membrane, which comprises the copolymer b-PAES of claim 1 in a polar organic solvent.

15. Shaped articles manufactured from the copolymer b-PAES of claim 1, being selected from the group consisting of membranes, melt processed films, solution processed films, melt process monofilaments and fibers, solution processed monofilaments, hollow fibers and solid fibers, coatings, printed objects, and injection and compression molded objects.

16. The bio-based sulfone copolymer b-PAES of claim 1, wherein in the recurring units (Rₐ) of formula (I), each R₂ is methyl at each location; each R₂* is methyl at each location, and the R₃ is selected from —CH₂— or —C(CH₃)₂—.

17. The process according to claim 8, wherein in the monomer of formula (A), each R₂ is methyl at each location; each R₂* is methyl at each location; and the R₃ is selected from —CH₂— or —C(CH₃)₂—.
